(19) United States
(12) Patent Application Publication
(10) Pub. No.: US 2014/0181879 A1
(43) Pub. Date: Jun. 26, 2014

(54) Device-adaptable contents generation device, contents Device-adaptable contents generation device, contents reproduction device, and method thereof

(71) Applicants: Myung Seok Ki, Seoul (KR); Jihun Cha, Seoul (KR); Injae Lee, Seoul (KR); Seong Yong Lim, Seoul (KR); SangHyun Park, Seoul (KR); Joong Yun Lee, Seoul (KR)

(72) Inventors: Myung Seok Ki, Seoul (KR); Jihun Cha, Seoul (KR); Injae Lee, Seoul (KR); Seong Yong Lim, Seoul (KR); SangHyun Park, Seoul (KR); Joong Yun Lee, Seoul (KR)

(73) Assignee: SK PLANET CO., LTD, Seoul (KR)

(21) Appl. No.: 14/009,274

(22) PCT Filed: Apr. 3, 2012
(86) PCT No.: PCT/KR12/02498

§ 371 Date: Mar. 11, 2014

(30) Foreign Application Priority Data
Apr. 4, 2011 (KR) 10-2011-0030755

(51) Int. Cl. H04N 21/2343

(52) U.S. Cl. CPC H04N 21/234363
USPC 725/109

(57) ABSTRACT

A device-adaptable contents generation device includes a media generation unit that generates, based on rich media content, basic level media having a first resolution and at least one extended level media having a higher resolution by stages than the first resolution, a metadata generation unit that generates metadata which allows selective access to the basic level media and the at least one extended level media generated by the media generation unit, a feature information generation unit that generates feature information about the rich media content, and a database that stores a file of the rich media content containing the feature information, the metadata, the basic level media and the at least one extended level media.

### TECHNICAL FIELD

The present invention relates generally to device-adaptable contents generation and reproduction, and more specifically to a device-adaptable contents generation device, contents reproduction device, and method thereof for adaptively reproducing contents to meet the resolution of a terminal device when the resolution of rich media contents generated based on MPEG LASeR (Lightweight Application Scene Representation) is different from the predetermined resolution of a terminal device.

### BACKGROUND ART

A conventional contents authoring technique aiming at general-purpose terminal devices is not suitable for providing multimedia contents now that mobile multimedia devices equipped with a variety of displays and resolutions are appearing.

For this reason, a contents authoring method or solution for allowing single content to be adapted to terminal devices with various specifications is widely considered. Currently, the most popular contents authoring method is to generate contents in high enough resolution size and to reduce,with a process of decoding carried out regardless of the specification of a terminal device, a rendering size to be adaptable to a low resolution of a terminal device.

This method, however, is impracticable in terms of decoding contents basically generated for high resolution to be adaptable to a low-end terminal device,though the method is available for a high-end terminal device.

Another method is to convert contents which have been produced using a special server or any other equivalent tool into a specific version suitable for a low-end terminal device. Further, the other method is to produce a wide range of versions of contents in consideration of the terminal devices of various specifications to be contained in one set of contents, and to allow reproduction of suitable content for a specification of a terminal device by selection or any other alternative way.

However, there still arise in these methods the problems with efficiency of content management and redundancy of content data in that the single content have to be equipped with many duplicate versions of the same content.

### DETAILED DESCRIPTION OF THE INVENTION

### Technical Problems

The present invention is to solve the above-mentioned problems. One object of the present invention is to provide, when rich media contents are authored based on MPEG LASeR (Lightweight Application Scene Representation), a device-adaptable contents generation device and method for forming, by steps, media data rendered for low resolution and media data rendered for high resolution.

Another object of the present invention is to provide a contents reproduction device and method for extracting and reproducing necessary media only from multistage media constituting contents, based on a resolution of a terminal device.

The object of the present invention is not limited to the above-mentioned objects, and any other objects not mentioned above will also be clearly understood,from the following descriptions, by those skilled in the art.

### Technical Solutions

According to one aspect of the present invention, a device-adaptable contents generation device in an embodiment of the present invention includes a media generation unit configured, based on rich media content, to generate basic level media having a first resolution and at least one extended level media having a higher resolution by stages than the first resolution, a metadata generation unit configured to generate metadata which allows selective access to the basic level media and the at least one extended level media generated by the media generation unit, a feature information generation unit configured to generate feature information about the rich media content, and a database configured to store a file of the rich media content containing the feature information, the metadata, the basic level media and the at least one extended level media.

The device-adaptable contents generation device in accordance with an embodiment of the present invention further includes a contents provision unit configured to selectively provide, in response to a request for the rich media content from a terminal device, the basic level media of the requested rich media content or both the basic level media and the at least one extended level media on the basis of specification information of the terminal device.

The device-adaptable contents generation device in accordance with an embodiment of the present invention further includes a contents provision unit configured to provide, in response to a request for the rich media content from a terminal device, the metadata, the feature information and the basic level media only corresponding to the requested rich media content, and then to selectively provide, in response to an additional request from the terminal device, the at least one extended level media.

According to another aspect of the present invention, a device-adaptable contents reproduction device in accordance with an embodiment of the present invention includes a contents analysis unit configured, based on both media information extracted from a file of content loaded from a contents generation device upon request and specification information of a terminal device, to determine a resolution suitable for reproduction of the loaded content, a media loading unit configured, based on the determined resolution, to load only basic level media contained in the loaded content or both the basic level media and at least one extended level media contained in the loaded content, a media combination unit configured to create a combined media by combining the basic level media and the at least one extended level media loaded from the media loading unit, and a media decoding unit configured to decode the basic level media or the combined media and to display the decoded media on a display unit.

In the contents reproduction device in accordance with an embodiment of the present invention, the contents analysis unit is further configured to determine the resolution suitable for reproduction of the content by comparing information about the basic level media with the specification information of the terminal device.

In the contents reproduction device in accordance with an embodiment of the present invention, the media loading unit is further configured, based on the determined resolution, to request and receive additionally, to and from the contents generation device, the at least one extended level media.

According to yet another aspect of the present invention, a device-adaptable contents reproduction method in accordance with an embodiment of the present invention includes steps of determining a resolution suitable for reproduction of content composed of multistage media, based on the determined resolution, generating a combined media by combining selectively the multistage media of the content, and decoding the combined media to reproduce the decoded media on a display unit.

In the contents reproduction method in accordance with an embodiment of the present invention, the step of determining the resolution includes loading the content received from a contents generation device upon request, and by comparing information about the loaded content with specification information of a terminal device, determining the resolution suitable for reproduction of the content.

In the contents reproduction method in accordance with an embodiment of the present invention, the step of generating the combined media includes extracting, based on the determined resolution, basic level media and at least one extended level media from the loaded content, and generating the combined media by utilizing the extracted basic level media and extended level media.

In the contents reproduction method in accordance with an embodiment of the present invention, the step of generating the combination media includes receiving basic level media among the multistage media of the content and associated information from the contents generation device upon request, and by comparing both the basic level media and the associated information with specification information of a terminal device, determining the resolution suitable for reproduction of the content.

In the contents reproduction method in accordance with an embodiment of the present invention, the step of generating the combined media includes based on the determined resolution, receiving at least one extended level media required for reproduction of the content from the contents generation device upon request, and generating the combined media by utilizing the received extended level media and the basic level media.

### Advantageous Effects

The present invention can provide a convenience of contents management by constructing rich media contents as multistage media and then storing the multistage media in a database, without having to prepare many duplicate versions of the same content in consideration of each specification of terminal devices having a contents reproduction device.

Also, the present invention, by constructing rich media contents as multistage media and then reproducing the rich media contents through a suitable combination of the multistage media based on information about specification of a terminal device, can ensure the positive effects for reducing redundancy of data and loads of terminal devices.

### DESCRIPTION OF THE DRAWING

FIG. 1 is a block diagram showing a network scheme including contents generation and reproduction devices in accordance with an embodiment of the present invention.

FIG. 2 is a diagram illustrating an example of constructing rich media contents as multistage media in accordance with an embodiment of the present invention.

FIG. 3 is a diagram illustrating a file structure of rich media contents in accordance with an embodiment of the present invention.

FIG. 4 is a flow diagram illustrating a process of reproducing rich media contents in accordance with an embodiment of the present invention.

### MODE FOR CARRYING OUT THE INVENTION

Advantages and features of this invention and methods of implementation will be clarified, referring to embodiments to be described hereinafter in detail with reference to accompanying drawings. However, the present invention is not limited to the embodiments described below and maybe implemented in other various forms which will be different from one another. Accordingly, the embodiments are only provided for the purpose of completing the start of the present invention and informing those who are skilled in the art of the complete scope of the present invention, and therefore the present invention will be defined only from the scope of the claims. All over the present specification, the same elements will be designated by the same reference numerals.

To avoid obscuring the subject matter of the present invention, while embodiments of the present invention are illustrated, well known functions or configurations will be omitted from the following descriptions. And the terms, which are defined pursuant to functions as described in accordance with embodiments of the present invention, may be altered depending on users, intentions of operators, or custom. Therefore, the definition of terms should be interpreted based on the overall content of this specification.

A combination of each block of the accompanying block diagram and each step of the accompanying flow diagram can be performed by computer program instructions. As these computer program instructions may be embedded with the processor of a general purpose computer, a special purpose computer, or other programmable data processing equipment, the program instructions to be carried out by the processor of computer or other programmable data processing equipment, can create a means whereby the functions as illustrated in each block of the block diagram and each step of the flow diagram can be performed. And as these computer program instructions may also be stored in computer-usable or computer-readable memory for supporting the computers or other programmable data processing equipments to implement the functions in a specific way, it will also be possible to provide a product containing therein the means of storing the program instructions whereby the functions as illustrated in each block of the block diagram and each step of the flow diagram can be performed. Also, as these computer program instructions can be embedded with computer or other programmable data processing equipment, a computerized process for carrying out a series of operations by steps, can be established by the embedded program instructions, through which the functions by steps as illustrated in each block of the block diagram and each step of the flow diagram can be provided for implementation.

Also, each block or each step may be a part of module, segment, or code which contains one or more practical instructions for implementing the specific logical functions. And it should be noted that, in some alternative embodiments, the functions as mentioned in blocks or steps can be implemented out of order. For example, a couple of blocks or steps illustrated one after another can actually be implemented either simultaneously or sometimes in reverse order depending on the corresponding function.

Hereinafter, embodiments of the present invention will be described in detail with reference to the accompanying drawings.

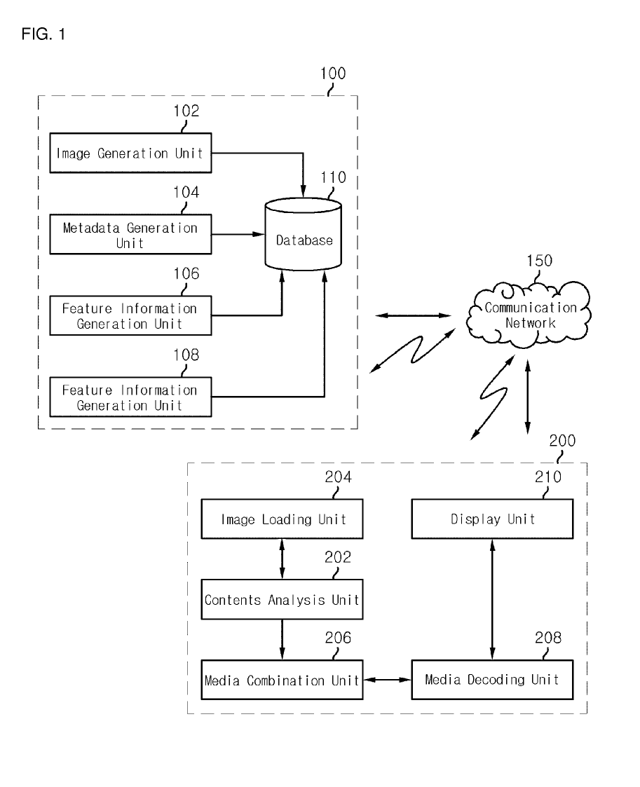

FIG. 1 is a block diagram illustrating a network scheme including rich media contents generation and reproduction devices in accordance with an embodiment of the present invention. Specifically, the network scheme may include a rich media contents generation device 100 and a rich media contents reproduction device 200, both of which are connected to a communication network 150.

Here, rich media contents a regenerated in anticipation of the highest specification of the contents reproduction device 200 and may be generated based on MPEG LASeR. MPEG LASeR is a mobile rich media standard, extending a SVC (Scalable Vector Coding) standard by adding items required for multimedia service. Including SVG (Scalable Vector Graphics) basically, the LASeR may enlarge or reduce graphic or animation components regardless of the resolution of the rich media reproduction device 200 such as mobile phone, smart phone, mobile computer, personal digital assistant (PDA), notebook, laptop computer, etc. or of a terminal device having the rich media reproduction device 200.

This rich media contents generation device 100 generates multistage media to be adaptable to a specific resolution or display specification of the rich media reproduction device 200, and transmits the generated multistage media to the rich media contents generation device 200 through the wired/wireless communication network 150.

The rich media contents generation device 100 in accordance with embodiments of the present invention, as shown in detail in FIG. 1, may include a media generation unit 102, a metadata generation unit 104, a feature information generation unit 106, a contents provision unit 108, and a database 110.

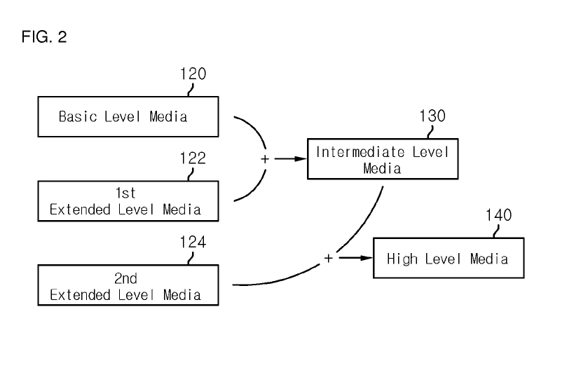

The media generation unit 102 reconstructs, from rich media content, a number of media with pyramid hierarchical structure in consideration of the resolution of the rich media contents reproduction device 200 or of the terminal device having the rich media contents reproduction device 200. For example, the media generation unit 102, as illustrated in FIG.2, may divide rich media content into a basic level media 120 and a first and a second extended level media 122 and 124 to be added to the basic level media 120. Here, the basic level media 120 is created for reproduction at the lowest resolution, and each of the first and second extended level media 122 and 124 is created for reproduction, by selectively combining with the basic level media 120, at a higher resolution than that of the basic level media 120.

Each of the first and second extended level media 122 and 124 may have a higher resolution by steps than that of the basic level media 120. A combination of the basic level media 120 and the first extended level media 122 may create an intermediate level media 130 to be reproduced at an intermediate-level resolution, and a combination of the intermediate level media 130 and the second extended level media 122 may create a highest level media 140 to be reproduced at the highest-level resolution.

The metadata generation unit 104 generates metadata which allows access to the multistage media which is generated by the media generation unit 102. The metadata generation unit 104 generates metadata for allowing selective access to, for example, the basic level media 120 and the first and second level media 122 and 124, and may store the generated metadata in ‘ilco/iinf’, a designated area of a rich media contents file. Accordingly, the rich media reproduction device 200, referring to the metadata stored in the designated area, can selectively access the basic level media 120 and the first and second extended level media 122 and 124 and then reproduce the rich media content.

The feature information generation unit 106 generates feature information about rich media contents, that is, information about LASeR file and about general media in the rich media contents. Here, the feature information may include media type, decoder type, media file size, associated information, and the like.

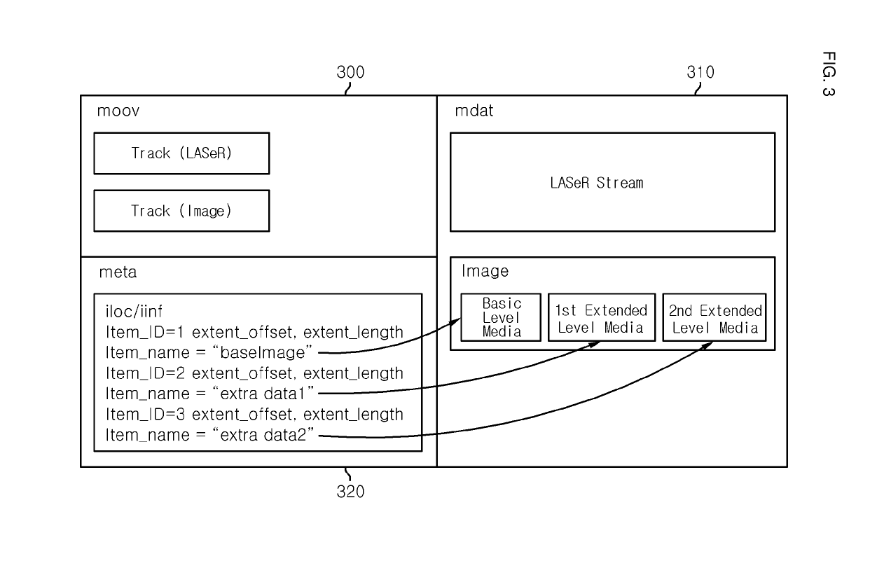

Through this configuration, the rich media contents may be stored in the form of the multistage media with feature information and metadata. For example, the rich media contents file, as illustrated in FIG. 3, is composed of an area moov 300 wherein the feature information of LASeR file and of media file is located, an area mdat 310 wherein LASeR stream about the rich media contents and the media by level are stored, and an area meta 320 wherein the metadata is stored.

The contents provision unit 108 can selectively provide only the basic level media 122 of rich media contents or at least one of the first and second extended level media 122 and 124 together with the basic level media 122, based on specification information of a terminal device at the request of the rich media contents reproduction device 200 of the terminal device. That is, if the terminal device is not able to reproduce the multistage media, only basic level media is provided and, if the terminal device is able to reproduce multistage media, at least one of the first and second extended level media 122 and 124 as well as the basic level media 122 can be selectively provided at the request of the rich media contents reproduction device 200 of the terminal device.

The rich media contents generation device 100 in accordance with embodiments of the present invention may enhance a convenience of contents management by constructing rich media contents as multistage media and storing the multistage media in the form of files in the database 110, without having to prepare many duplicate versions of the same content in consideration of each specification of the rich media contents reproduction device 200 or of the terminal device equipped with the rich media contents reproduction device.

Media in embodiments of the present invention may include not only image data but also multimedia stream that is composed of video and audio data.

On the other hand, the rich media contents reproduction device 200, which is intended to reproduce rich media contents on request via the communication network 150, may include a contents analysis unit 202, a media loading unit 204, a media combination unit 206, a media decoding unit 208, and a display unit 210.

The contents analysis unit 202 extracts LASeR stream from the mdat area 310 of a rich media content file which is received from the rich media contents generation device 100, extracts scene size information of the rich media content, compares the extracted scene size information with specification information of a terminal device, determines the resolution of the rich media content to be reproduced by the rich media contents reproduction device 200, and checks whether or not the rich media content includes multistage media. Then, the determined resolution and the information about the multistage media may be provided to the media loading unit 204. Here, the specification information of a terminal device may include the resolution supported by the terminal device, the size of the display unit 210, and the like.

The contents analysis unit 202, when multistage media is included in rich media contents, may determine the type of the extended level media to be requested on the basis of the determined resolution, and then request, from the rich media contents generation device 100, the determined extended level media, e.g., the first extended level media 122. Accordingly, the media loading unit 204 may receive the first extended level media 122 from the rich media generation device 100, and transmit the received first extended level media 122 to the media combination unit 206.

The media loading unit 204 may extract, from the rich media contents which are loaded onto the rich media contents reproduction device 200, a necessary media on the basis of the resolution determined by the contents analysis unit 202.

The media combination unit 204 may generate a combination media by combining the basic level media 120 with the first extended level media 122 or the second level media 124, and then transmit the combination media to the media decoding unit 208.

The media decoding unit 208 may decode the combination media and reproduce the decoded images, graphics, text data, and the like by rendering them to the display unit 210.

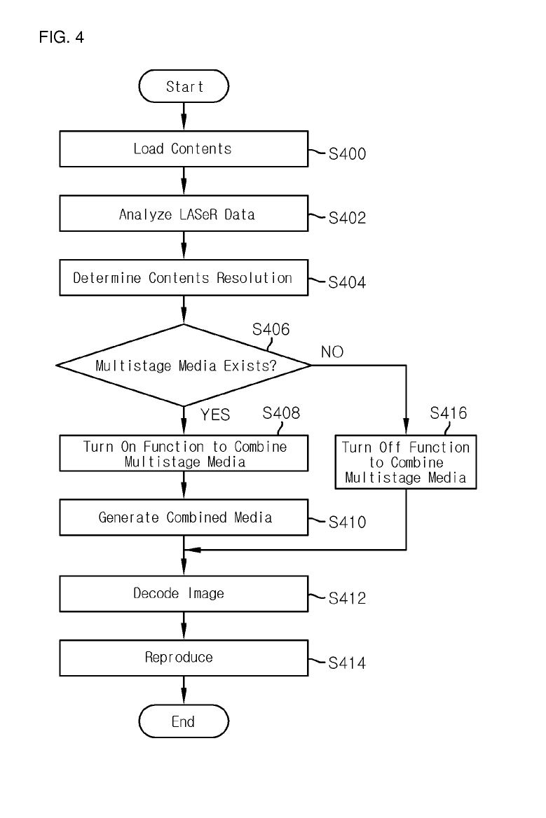

A rich media contents reproduction process performed by the rich media contents reproduction device 200 having the above-discussed configuration will be described hereinafter with reference to FIG. 4.

FIG. 4 is a flow diagram illustrating a process of reproducing rich media contents in accordance with an embodiment of the present invention.

As shown in FIG. 4, the rich media reproduction device 200 requests, at the request of a user, rich media content from the rich media contents generation device 100. Then, the contents provision unit 108 of the rich media contents generation device 100 may transmit a file of the requested rich media content to the rich media reproduction device 200, that is, rich media content having a file structure as illustrated in FIG. 3. Therefore,the media loading unit 204 of the rich media contents reproduction device 200 loads the rich media content file received from the rich media contents generation device 100 (S400). Hereafter, the contents analysis unit 204 analyzes LASeR stream and media in the mdat area 310 of the loaded rich media content file (S402), extracts scene size information of the rich media content, compares the extracted scene size information with specification information of a terminal device, e.g., the resolution and size of the display unit 210, and determines the resolution of the rich media content to be rendered to the rich media contents reproduction device 200 (S404).

Hereafter, the contents analysis unit 202 checks if there is multistage media in the rich media content (S406). Namely,the contents analysis unit 202 may determine whether or not multistage media is contained in the rich media content by analyzing information of the mdat area 310 or the meta area 320 of the rich media content.

When any multistage media is contained in the rich media content as a result of checking at step S406, the media loading unit 204 turns on a function to combine multistage media (S408), and, based on the determined resolution, extracts, from media loaded onto the rich media contents reproduction device 200, only a necessary media such as the basic level media 120 and the first extended level media 122, and transmits the retrieved media to the media combination unit 206.

Then, the media combination unit 206 generates a completely combined media resulting from a combination of the basic level media 120 and the first extended level media 122 (S410).

After this, the media decoding unit 208 decodes the combined media (S412), and reproduces the rich media content adapted to the resolution of the rich media contents reproduction device 200 by displaying, on the display unit 210, images, graphics, text data, etc. of the decoded media (S414).

Conversely, when no multistage media is contained in the rich media content as a result of checking at step S406, the media loading unit 204 turns off a function to combine multistage media, and reproduces the rich media content received from the rich media contents generation device 100 (S412).

Although it is described hereinbefore that the contents reproduction device in accordance with embodiments of the present invention loads the entire rich media content, this is exemplary only. Alternatively, only the basic level media may be loaded first and, depending on the determined resolution, a certain type of extended level media can be loaded upon request. In other words, the media loading unit 204 may request and receive, to and from the rich media generation device 100, the first or the second extended level media 122 or 124 depending on the determined resolution.

According to embodiments of the present invention,by constructing multistage media from rich media content and by reproducing the rich media content through a selective combination of the multistage media on the basis of the specification of a terminal device, the redundancy of data and the load of a terminal device can effectively be reduced.

While the embodiments of the present invention has been shown and described as mentioned above with reference to the accompanying drawings, it will be understood by those skilled in the art that various changes in forms and details may be made therein without departing from the subject matter of the invention. For example, those skilled in the art may change each constituent element according to the field of application or may implement the invention, by combining or replacing the forms of implementation, in the form that is not distinctly illustrated in the embodiments of this invention. However, those changes will not digress from the scope of the invention. Therefore, the embodiments as described above should be understood in every respect, not as limitation, but as exemplification, and those altered embodiments should be regarded as included in the subject matter of this invention.

### INDUSTRIAL APPLICABILITY

The contents generation device in accordance with embodiments of the present invention can be utilized as effective content management technology for contents which are provided to terminal devices with various specifications like mobile communication devices.

Also, the contents reproduction device in accordance with embodiments of this invention can be used as technologies not only for reproduction of contents composed of multistage media, but also for reduction of loads of terminal devices.

What is claimed is:

1. A device-adaptable contents generation device comprising:
a media generation unit configured, based on rich media content, to generate basic level media having a first resolution and at least one extended level media having a higher resolution by stages than the first resolution;
a metadata generation unit configured to generate metadata which allows selective access to the basic level media and the at least one extended level media generated by the media generation unit;
a feature information generation unit configured to generate feature information about the rich media content; and
a database configured to store a file of the rich media content containing the feature information, the metadata, the basic level media and the at least one extended level media.

2. The device-adaptable contents generation device of claim 1, further comprising:
a contents provision unit configured to selectively provide, in response to a request for the rich media content from a terminal device, the basic level media of the requested rich media content or both the basic level media and the at least one extended level media on the basis of specification information of the terminal device.

3. The device-adaptable contents generation device of claim 1, further comprising:
a contents provision unit configured to provide, in response to a request for the rich media content from a terminal device, the metadata, the feature information and the basic level media only corresponding to the requested rich media content, and then to selectively provide, in response to an additional request from the terminal device, the at least one extended level media.

4. A device-adaptable contents reproduction device comprising:
a contents analysis unit configured, based on both media information extracted from a file of content loaded from a contents generation device upon request and specification information of a terminal device, to determine a resolution suitable for reproduction of the loaded content;
a media loading unit configured, based on the determined resolution,to load only basic level media contained in the loaded content or both the basic level media and at least one extended level media contained in the loaded content;
a media combination unit configured to create a combined media by combining the basic level media and the at least one extended level media loaded from the media loading unit; and
a media decoding unit configured to decode the basic level media or the combined media and to display the decoded media on a display unit.

5. The device-adaptable contents reproduction device of claim 4, wherein the contents analysis unit is further configured to determine the resolution suitable for reproduction of the content by comparing information about the basic level media with the specification information of the terminal device.

6. The device-adaptable contents reproduction device of claim 5, wherein the media loading unit is further configured, based on the determined resolution, to request and receive additionally, to and from the contents generation device, the at least one extended level media.

7. A device-adaptable contents generation method comprising steps of:
generating basic level media having a first resolution on the basis of rich media content;
generating at least one extended level media having a higher resolution by stages than a first resolution of the basic level media;
generating metadata for allowing selective access to the basic level media and the at least one extended media;
generating feature information about the rich media content; and
storing a file of the rich media content containing the feature information, the metadata, the basic level media and the at least one extended level media in a database.

8. The device-adaptable contents generation method of claim 7, further comprising step of:
in response to a request for the rich media content from a terminal device, providing selectively the basic level media of the requested rich media content or both the basic level media and the at least one extended level media to the terminal device on the basis of specification information of the terminal device.

9. The device-adaptable contents generation method of claim 7, further comprising steps of:
in response to a request for the rich media content from a terminal device, providing the metadata,the feature information and the basic level media corresponding to the requested rich media content to the terminal device; and
in response to an additional request from the terminal device, providing selectively the at least one extended level media to the terminal device.

10. A device-adaptable contents reproduction method comprising steps of:
determining a resolution suitable for reproduction of content composed of multistage media;
based on the determined resolution, generating a combined media by combining selectively the multistage media of the content; and
decoding the combined media to reproduce the decoded media on a display unit.

11. The device-adaptable contents reproduction method of claim 10, wherein the step of determining the resolution includes:
loading the content received from a contents generation device upon request; and
by comparing information about the loaded content with specification information of a terminal device, determining the resolution suitable for reproduction of the content.

12. The device-adaptable contents reproduction method of claim 11, wherein the step of generating the combined media includes:
extracting, based on the determined resolution, basic level media and at least one extended level media from the loaded content; and
generating the combined media by utilizing the extracted basic level media and extended level media.

13. The device-adaptable contents reproduction method of claim 10, wherein the step of generating the combination media includes:
receiving basic level media among the multistage media of the content and associated information from the contents generation device upon request; and
by comparing both the basic level media and the associated information with specification information of a terminal device, determining the resolution suitable for reproduction of the content.

14. The device-adaptable contents reproduction method of claim 13, wherein the step of generating the combined media includes:
based on the determined resolution, receiving at least one extended level media required for reproduction of the content from the contents generation device upon request; and
generating the combined media by utilizing the received extended level media and the basic level media.
